(19) United States
(12) Patent Application Publication
(10) Pub. No.: US 2011/0267520 A1
(43) Pub. Date: Nov. 3, 2011

(54) SYSTEM FOR CAPTURING IMAGES AND RELATED USE FOR IMPROVING THE QUALITY OF THE IMAGES ACQUIRED

(75) Inventors: Marine Pyanet, Paris (FR); Cesar Douady, Orsay (FR); Frederic Guichard, Paris (FR); Hoang-Phi Nguyen, Paris (FR); Bruno Liege, Boulogne (FR)

(73) Assignee: DXO LABS, Boulogne Billancourt (FR)

(21) Appl. No.: 13/143,166

(22) PCT Filed: Dec. 17, 2009
(86) PCT No.: PCT/FR2009/052604

§ 371 Date: Jul. 1, 2011

(30) Foreign Application Priority Data
Jan. 6, 2009 (FR) 09 50055

(51) Int. Cl. H04N 5/335

(52) U.S. Cl. 348/296; 348/E05.091

(57) ABSTRACT

A system for capturing images includes a sensor with a plurality of photosensitive elements, an optical system for focusing the light towards the sensor, and an electronic rolling shutter arranged so as to expose the photosensitive elements to light at moments that depend on the relative positions thereof inside the sensor. The system for capturing images also includes a means for adapting, at each of at least two distinct given moments while capturing an image, the light focus towards the sensor and/or the light exposure for at least part of the photosensitive elements exposed to the light at said moment.

The present invention relates to a system for capturing images.

Such system for capturing images (fixed or animated according to circumstances) can for example be a module suitable for use in a digital camera, a reflex camera, a scanner, a fax, an endoscope, a camera head, a camcorder, a surveillance camera, a toy, a filming unit, a camera incorporated into or connected to a phone, a personal digital assistant or a computer, a thermal camera, an ultrasound device, an MRI (Magnetic Resonance Imaging) device, an X-ray radiography device, etc.

It comprises conventionally a sensor including a plurality of photosensitive elements (for example pixels) which transform a quantity of light received into digital values, and an optical system comprising one or more lenses for focusing the light towards the sensor.

The sensor can be for example a CCD (Charged Coupled Device), CMOS (Complementary Metal Oxide Semiconductor), CID (Charge Induced Device), IRCCD (Infra-Red CCD), ICCD (Intensified CCD), EBCCD (Electron Bombarded CCD), MIS (Metal Insulator Semiconductor), APS (Active Pixel Sensor), QWIP (Quantum Well Infrared Photodetectors), MQW (Multiple Quantum Well), or other detector. It can optionally be combined with a filter, for example a Bayer or also a panchromatic filter in order to obtain a colour image.

The light received on each photosensitive element of the sensor is not necessarily assimilated simultaneously. For example, in a digital photographic device, light can be received by scanning successive lines of photosensitive elements of the sensor, the lines following the largest dimension of the sensor. Such scanning is obtained using an electronic rolling shutter or ERS.

Due to this scanning, each line of photosensitive elements of the sensor receives an item of information from the scene to be captured during the same exposure time, but the exposure starts at a different moment for each line.

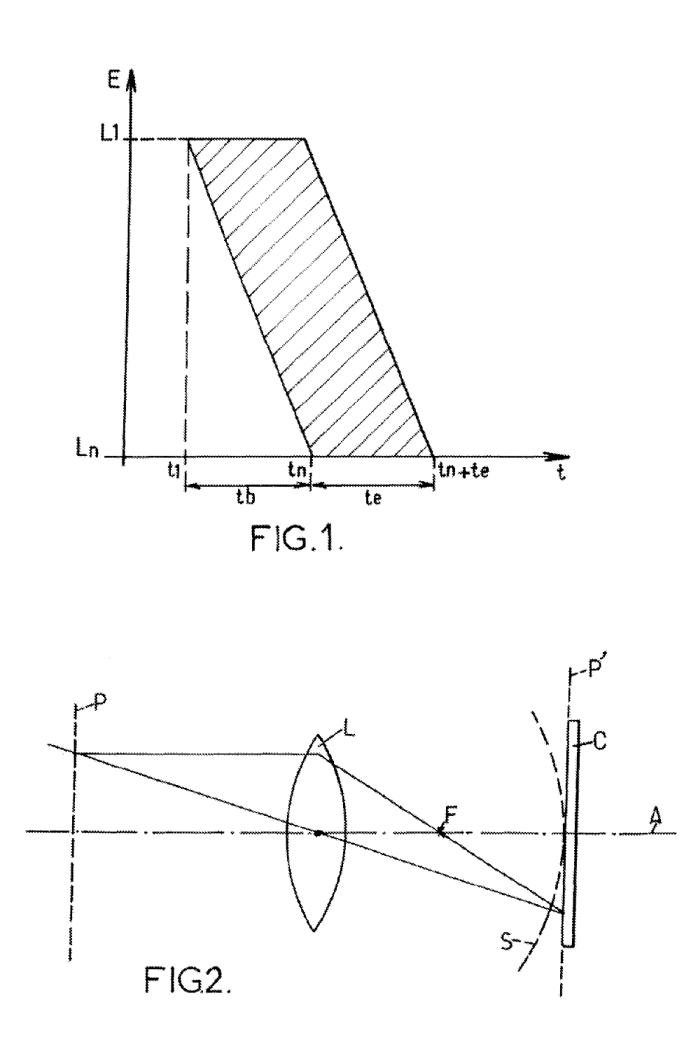

This phenomenon is shown in FIG. 1, which represents the exposure E of the n lines, L1 to Ln, of photosensitive elements of the sensor during time t.

The electronic rolling shutter first exposes to light the first line L1 of the sensor, starting from time t1. This line L1 then remains exposed to the light for an exposure time te, i.e. until time t1+te.

The electronic rolling shutter starts the exposure of the second line of the sensor after the first one, and so on until the last line Ln of the sensor.

The last line Ln is thus exposed to light between time tn and time tn+te.

The scan time tb from the first to the last line of the sensor can therefore be defined as tn−t1.

In total, lines of the sensor are exposed to light between time t1 and time tn+te, i.e. over a total duration of tn+te−t1.

Moreover, a given line is not necessarily fully exposed to light at a given moment. Quite the contrary, the exposure to light can start at successive moments for the different photosensitive elements constituting this line.

Due to the electronic rolling shutter, only a part of the sensor can thus be exposed to light at a given moment. This part changes over time and increases as the exposure time (or duration of exposure) divided by the scan time increases.

By virtue of its method of operation, the electronic rolling shutter makes it possible to avoid the use of a mechanical shutter and therefore to reduce cost, while allowing digital processing to be carried out as an image is captured, which may possibly compensate for the lack of sufficient memory to store the whole of the data originating from the capture.

It can however result in unwanted phenomena, such as deformation of the image of an object that is moving rapidly during the capture.

More generally according to the invention, by electronic rolling shutter (ERS) is meant any device making it possible to expose the photosensitive elements of the sensor to light at moments that depend on the relative positions thereof inside the sensor. The scanning can be by line, by column but also according to another pattern for example from the edge towards the centre or the reverse, or any other pattern. The scanning can be carried out by acting on the controlling electronics of the photosensitive elements but also using an optical device masking a part of the photosensitive elements or any other means.

Moreover, the quality of the images obtained is a major criterion in the evaluation of a system for capturing images, for which improvements are constantly sought by various actions ranging from the design of the optical system to optimization of the digital processing algorithms used on the captured images.

By way of non-limitative examples of phenomena likely to degrade the quality of the images, there can be mentioned focus defects and poor exposure of the image.

A typical focus defect is field curvature. This phenomenon, shown diagrammatically in FIG. 2, means that the image of a plane P via an optical system L generally does not form on a conjugate plane P′ of P via the optics L, but on a curved surface S. This surface S is for example spherical and has the optical axis A as its axis of rotation.

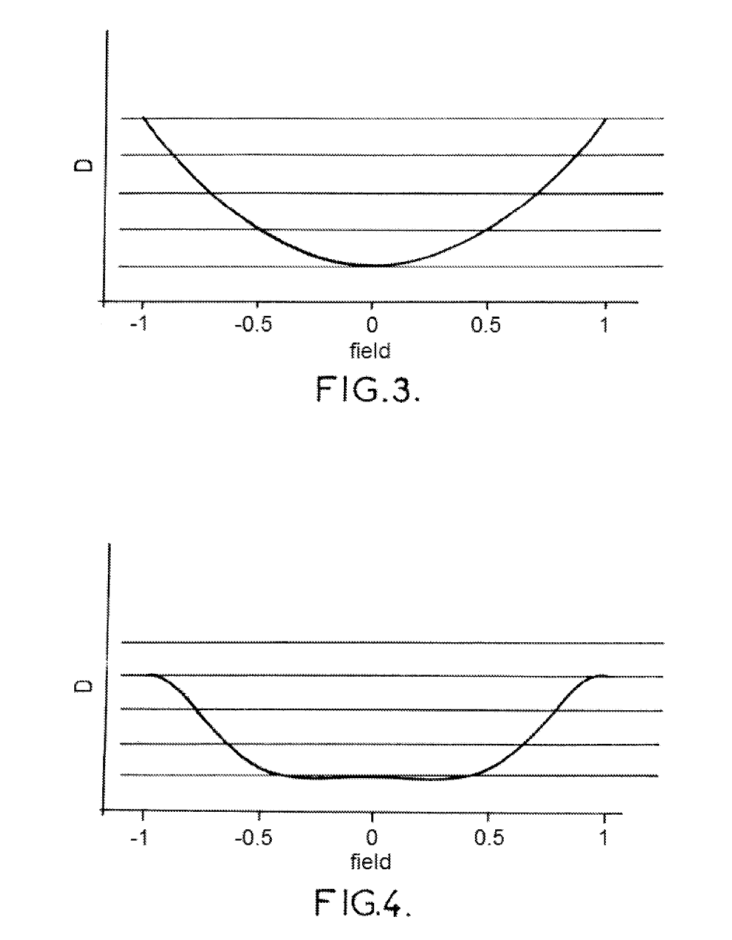

FIG. 3 shows an example of divergence D between the actual focal point of the rays and the image plane P′ (i.e. the plane perpendicular to the conjugate optical axis of the object plane P via the optical system) as a function of the normalized field. The spherical shape of the field curvature is found therein.

Thus, when the sensor C is planar, the acquired image cannot be perfectly focused simultaneously in each point of the field.

In practice, this is a defect that is very obvious in the images, as the presence of field curvature is generally manifested by a degradation of the level of sharpness at the edge of field.

It is known to compensate partially for this aberration by a modified design of the optical system, by acting in particular on the number, the shape and properties of the lenses. Most of the time, this compensation is however only partial and does not allow the defect to be eliminated completely.

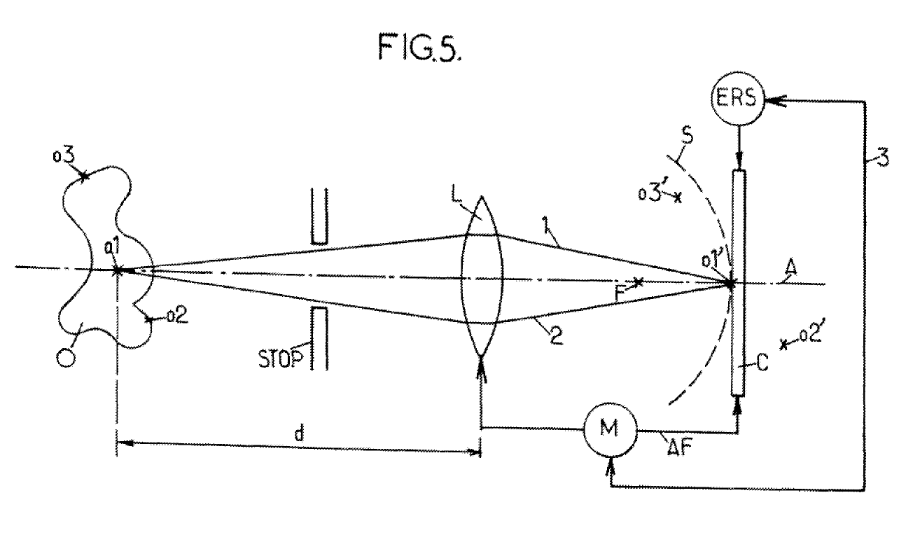

FIG. 4 shows an example of divergence D between the focal point and the image plane as a function of the normalized field for a system for which the optics were designed to limit the field curvature effect.

It is noted that the field curvature is no longer spherical. The field is even practically planar at the centre. A curvature however appears at the edge of field, although in an attenuated fashion in comparison with the uncorrected situation as shown in FIG. 3.

In addition to making the optical system more complex and therefore increasing its cost, such a correction is likely to introduce other defects and/or a relaxation of other criteria.

Another known manner of compensating for the field curvature introduced by the optical system consists, for certain film-based photographic devices, of producing a physical curvature of the film.

This solution is however more difficult to implement in the case of a digital sensor. Designing a digital sensor having a spherical shape encompassing focus variations due to the field curvature would be particularly complex and costly.

Although the above-mentioned corrections can have a degree of efficacy with respect to the field curvature introduced by the optical system, instances of poor focus can persist in the image due to the depth of field of the system for capturing images, which defines a range of object distances for which the captured images are sharp.

In fact, a scene to be captured containing both near and distant objects results in different focusings according to the zones of the image corresponding to these objects. As the scene is not known in advance, this phenomenon cannot be compensated for by a fixed parametering at the design stage of the system.

As regards the poor exposure of the image, it can for example result from differences in brightness within the scene to be captured. This is typically the case of back lighting. In the case of a backlit portrait, the image of the person photographed is actually under-exposed, while the background image is overexposed.

Even in the absence of variations in brightness within the scene to be captured, the appropriate exposure can be difficult to determine. This is particularly the case of photos taken in low light.

The defect of certain systems for capturing images, commonly called vignetting, which is manifested by an unequal distribution of light in the image (the brightness being generally greater at the centre than at the periphery of the image), also increases the difficulty of determining a suitable exposure.

An aim of the present invention is to improve the quality of the captured images while limiting at least some of the above-mentioned defects.

To this end, it exploits the existence of an electronic rolling shutter and varies certain parameters and/or certain features of the capture system during scanning.

The invention thus proposes a system for capturing images comprising a sensor including a plurality of photosensitive elements, an optical system for focusing light towards the sensor and an electronic rolling shutter arranged in order to expose the photosensitive elements to light at moments that depend on the relative positions thereof inside the sensor. This system for capturing images also comprises means for adapting, at a given moment, the focusing of light towards the sensor and/or the exposure to light for at least part of the photosensitive elements exposed to light at said given moment.

This adaptation, carried out synchronized with the action of the electronic rolling shutter, makes it possible to improve the quality of the images acquired, in terms of sharpness, brightness, or other.

According to the extent of the adaptation, the improvement in the quality can be obtained on a portion of the acquired image (if a single adaptation limited to a subset of photosensitive elements of the sensor is used for example), or on the whole of the acquired image (if adaptations are implemented successively on portions covering the whole of the sensor for example).

In fact, the adaptation can be carried out at a single given moment, in order to adapt the focusing of light towards the sensor and/or the exposure to light for only the portion of the photosensitive elements exposed to light at this given moment by the ERS. It can however also be carried out at least two distinct moments, so as to obtain a focusing of light towards the sensor and/or an exposure to light adapted to at least two parts of the sensor exposed to light by the ERS at these moments. Potentially there are then different focusings and/or exposures at least two separate points of the captured image. If the adaptation is repeated at moments covering the whole of the scanning time of the sensor by the ERS, it can allow a focusing of light towards the sensor and/or an optimal exposure to light for all the photosensitive elements of the sensor.

The means for adapting the focusing of light towards the sensor and/or the exposure to light can be various. They can for example comprise an autofocus system or other system arranged in order to provide a relative displacement between the optical system and the sensor, synchronized with the electronic rolling shutter.

As an alternative or in addition, the means for adapting the focusing of light towards the sensor and/or the exposure to light can comprise means of changing the shape and/or property of the optical system and/or of the sensor and/or of the system for capturing images, synchronized with the electronic rolling shutter.

According to the invention, by autofocus system is meant any system arranged in order to provide a relative displacement between the optical system and the sensor whatever the type of displacement. As an alternative or in addition, they can comprise means of changing a shape and/or a property of the optical system, synchronized with the electronic rolling shutter. As an alternative or in addition, they can comprise means for adjusting the aperture of the optical system, synchronized with the electronic rolling shutter.

As an alternative or in addition, the means for adapting the focusing of light towards the sensor and/or the exposure to light can comprise means of selecting a gain factor and/or an exposure time, synchronized with the electronic rolling shutter.

As an alternative or in addition, the means for adapting the focusing of light towards the sensor and/or the exposure to light can comprise a lighting module for lighting a scene to be captured, the light intensity of which is adjusted in a manner synchronized with the electronic rolling shutter.

As an alternative or in addition, the means for adapting the focusing of light towards the sensor and/or the exposure to light can comprise a variable aperture device, in particular a diaphragm of the optical system, the aperture of which is adjusted in a manner synchronized with the electronic rolling shutter.

As an alternative or in addition, the means for adapting the focusing of light towards the sensor and/or the exposure to light can comprise a variable focus device, in particular an optical zoom the focal length of which is adjusted in a manner synchronized with the electronic rolling shutter.

Other means for adapting the focusing of light towards the sensor and/or the exposure to light can be envisaged in order to improve the quality of the acquired images.

The invention also proposes a use, in order to improve the quality of the acquired images, of a system for capturing images as mentioned above, comprising a sensor including a plurality of photosensitive elements, an optical system for focusing light towards the sensor and an electronic rolling shutter arranged in order to expose the photosensitive elements to light at moments that depend on the relative positions thereof inside the sensor. According to this use, at a given moment, the focusing of light towards the sensor and/or the exposure to light are adapted, for at least part of the photosensitive elements exposed to light at said given moment.

The adaptation can be repeated at successive moments, optionally until it has involved all of the photosensitive elements of the sensor.

Other features and advantages of the present invention will become apparent from the following description of non-limitative embodiments, with reference to the attached drawings, in which:

FIG. 1, already mentioned, is a diagram representing an exposure of the lines of photosensitive elements of a sensor over time, by the effect of an electronic rolling shutter;

FIG. 2, already mentioned, is a diagram showing the field curvature effect;

FIGS. 3 and 4, already mentioned, are curves showing the field curvature effect respectively in an uncorrected system and in a system the optics of which were designed in order to limit this effect;

FIG. 5 is a diagram showing an example system for capturing images according to the invention (the autofocus system AF being optional in certain embodiments of the invention);

FIG. 6 is a diagram showing responses of a sensor at successive moments;

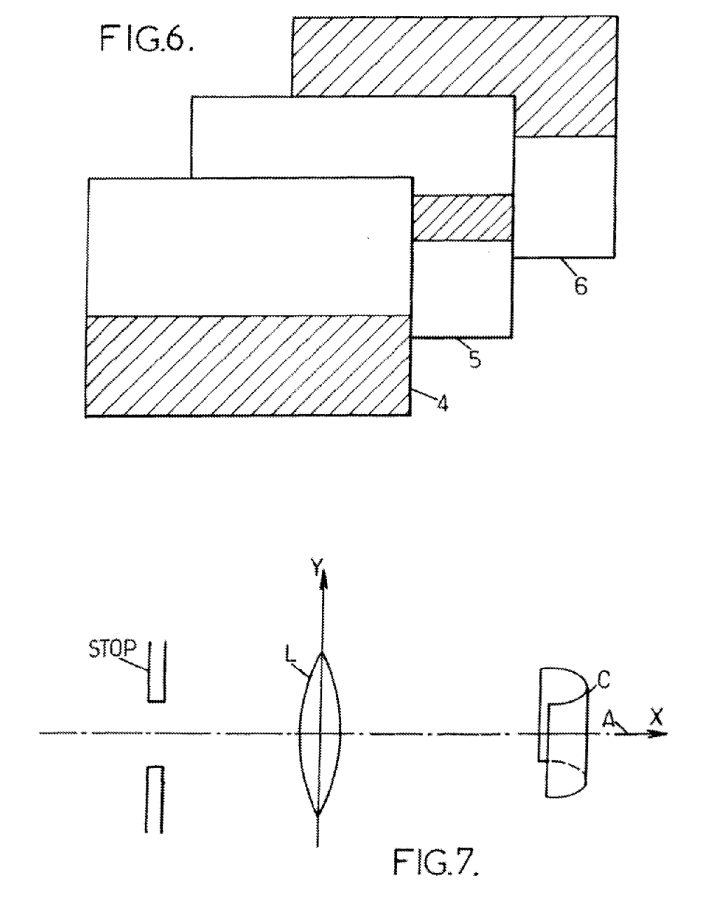

FIG. 7 is a diagram showing an example system for capturing images the sensor of which has a curvature in one direction;

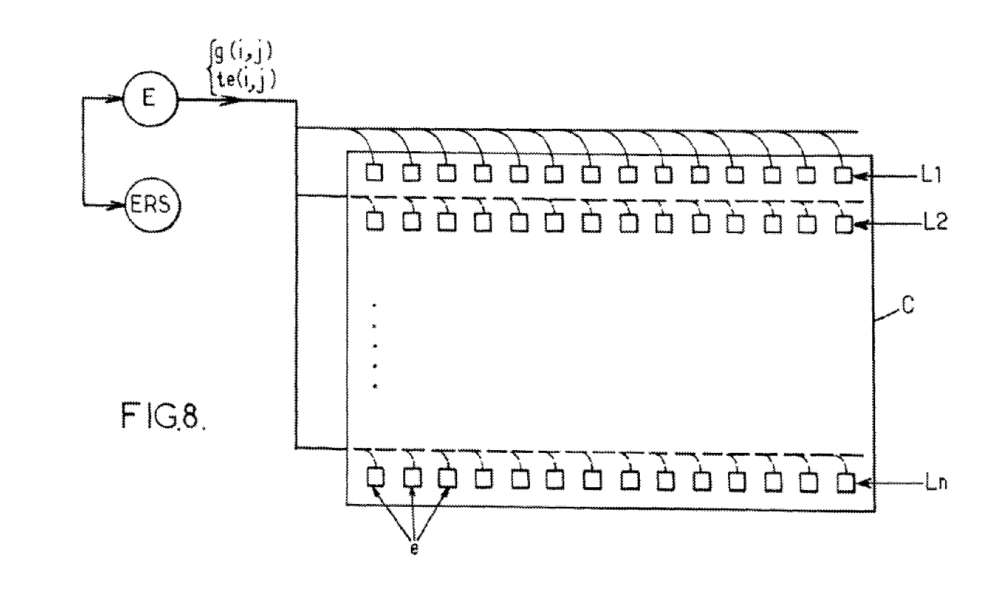

FIG. 8 is a diagram showing the sensor of an example system for capturing images according to an embodiment of the invention;

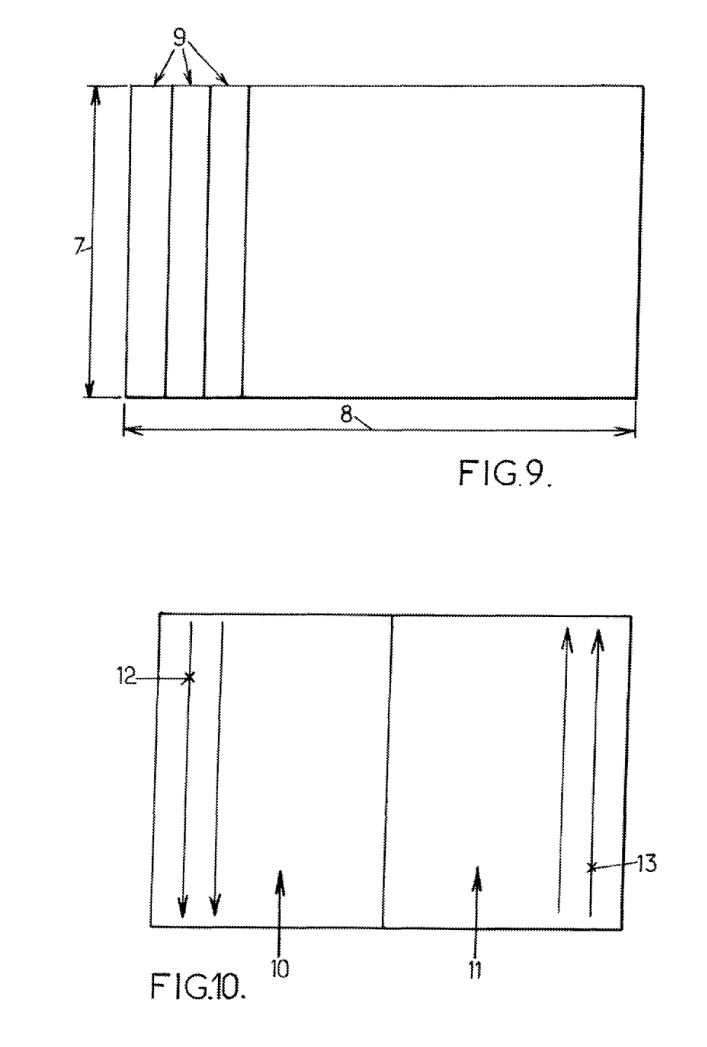

FIG. 9 is a diagram showing an example of scanning of a sensor by lines following the smallest dimension of the sensor (column);

FIG. 10 is a diagram showing an example of symmetrical and simultaneous scanning of two halves of a sensor;

FIG. 11 is a diagram showing an example of scanning of a sensor with a reduced exposure time;

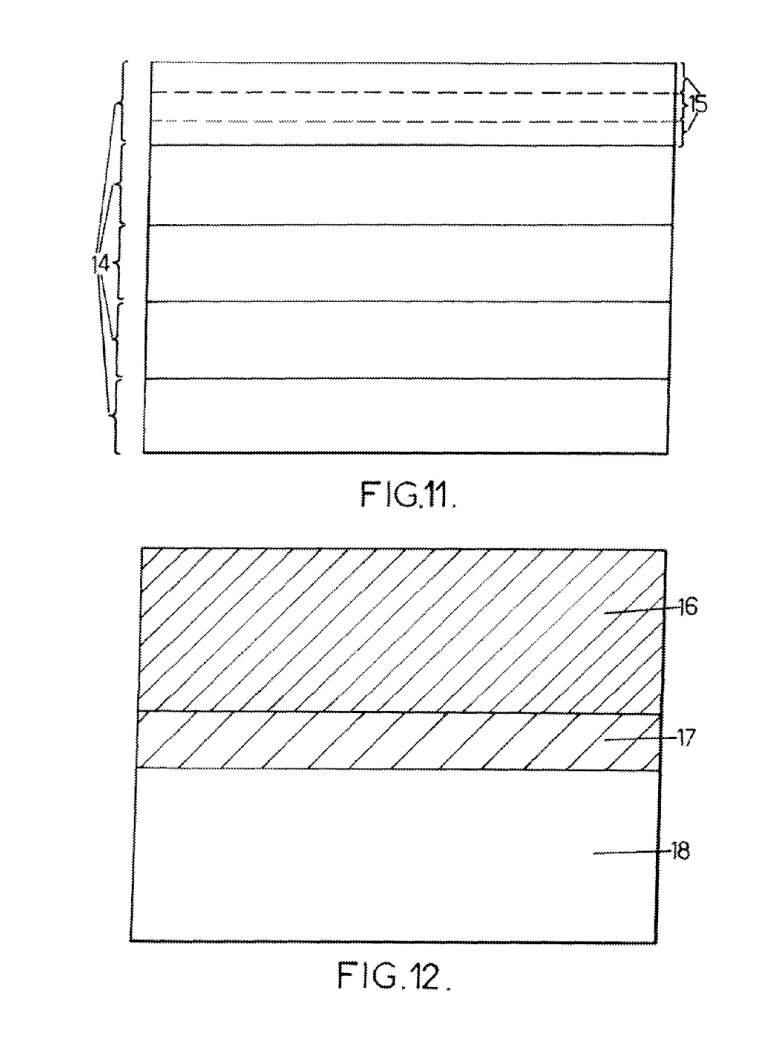

FIG. 12 is a diagram showing the characteristics of an image obtained in pre-capture view; and

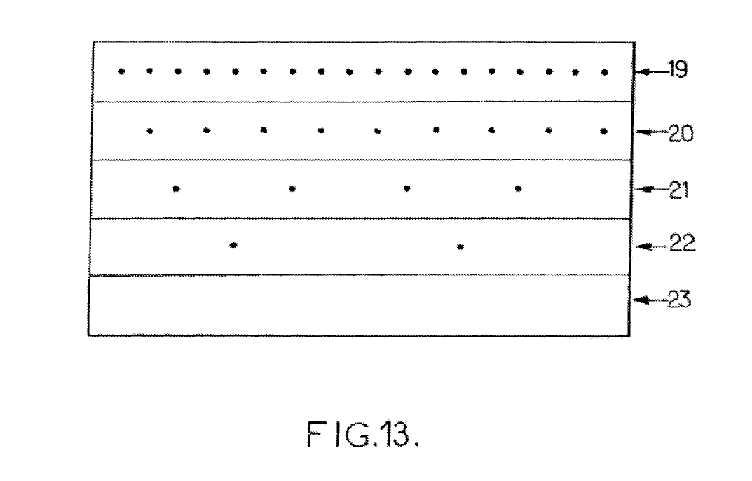

FIG. 13 is a diagram showing the characteristics of another image obtained in pre-capture view.

FIG. 5 shows a non-limitative example of a system for capturing images according to the invention.

This system comprises a sensor C including a plurality of photosensitive elements (for example pixels) and an optical system L for focusing light towards the sensor C. The sensor C and the optical system L can be conventional and according to the description given in the introduction.

This system for capturing images also comprises an electronic rolling shutter (hereinafter ERS) arranged in order to expose the photosensitive elements of the sensor C to light at moments that depend on the relative positions thereof inside the sensor.

The ERS can also be conventional and according to the description given in the introduction. By way of example, it can carry out scanning by successive lines of photosensitive elements of the sensor. Alternatively, the ERS used within the framework of the present invention can carry out other types of scanning, some examples of which will be described below.

The system for capturing images according to the invention also comprises means for adapting, at a given moment, the focusing of light towards the sensor C and/or the exposure to light for at least part of the photosensitive elements exposed to light at said given moment (this part being capable of representing the entirety or only a subset of the photosensitive elements exposed to light at said given moment by the action of the ERS).

These means of adaptation can adopt various forms, according to the type of improvement in the quality of the captured images that it is sought to obtain.

In a first embodiment, these means include an autofocus system AF arranged in order to provide a relative displacement between the optical system L and the sensor C, for example using a motor M.

This displacement is advantageously a translational movement along the optical axis A of the system for capturing images, although other movements can also be envisaged, for example along axes perpendicular to the optical axis in order to obtain an image stabilization effect. When the optical system L comprises a plurality of lenses, only a part of them may optionally undergo a relative displacement with respect to the sensor C.

The autofocus system AF is moreover synchronized with the ERS (as symbolized by the double-headed arrow 3) in order at a given moment to adapt the focusing of light towards the sensor C for a part of the photosensitive elements exposed to light at said given moment by the action of the ERS.

Thus, the autofocus system AF can allow a relative displacement between the optical system L and the sensor C such that the focus of the rays is the best possible in the part exposed at a given moment by the ERS.

For example, when the optical system L introduces a field curvature, for example spherical, the autofocus system AF can take account of this field curvature in order to adapt the focusing of light in relation to the part of the sensor exposed to light at a given moment. This means that, by the action of the autofocus AF, the sensor C can follow at least partially the field curvature introduced by the optical system L.

Thus, when the field curvature introduced by the optical system L transforms the image of a plane into a curved surface S, such as a spherical surface having the optical axis A as axis of rotation, the autofocus system AF can ensure that the sensor C is displaced following this curve S as the ERS progressively exposes the different photosensitive elements of the sensor C.

By way of illustration, FIG. 5 shows a relative position of the system L and the sensor C adapted in order to optimize the focusing of light for photosensitive elements situated at the centre of the sensor.

The optical system L and the sensor C would on the other hand be brought into positions that are closer to each other, by the autofocus system AF, when the ERS exposes to light the photosensitive elements situated at the top or at the bottom of the sensor C.

If the ERS carries out a scan of the sensor by successive lines from top to bottom, the autofocus system AF then results in progressively distancing the optical system L and the sensor C from each other until reaching the position shown in FIG. 5, then moving them progressively closer to each other.

In this way, a virtual curvature of the planar sensor C is introduced, which provides a correction of the field curvature of the same type as that obtained by an actual curvature of a film-based sensor as mentioned in the introduction.

It will be noted that a compromise could be sought between the improvement in the sharpness of the captured images and the number of displacements carried out by the autofocus system. Moreover, the displacement speed permitted by the autofocus system can constitute a limit to be taken into account in defining the proportion of the photosensitive elements exposed to light for which the focusing must be adapted.

It will also be understood that, when the system arranged to provide a relative displacement between the optical system L and the sensor permits displacements other than translational movements along the optical axis A of an autofocus AF, the latter can be exploited in order to better follow the curve S in its components that are other than longitudinal and/or to compensate for a movement of the system for capturing images and/or to compensate for a manufacturing defect such as an asymmetrical focus defect associated with a difference between the optical axis of the optical system (L) and the perpendicular axis at the centre of the sensor.

As the system, in particular the autofocus AF, arranged in order to provide a relative displacement between the optical system L and the sensor, is synchronized with the ERS, the relative displacement of the optical system L and the sensor C that it allows can be regarded as dependent on the exposure time of the photosensitive elements, the speed of electronic scanning and the direction of scanning permitted by the ERS. This displacement can moreover depend on the focal length, the aperture or also the type of optics and sensor of the system.

In the above description, it has been assumed that the sensor C was planar. Any other shape of the sensor can nevertheless be envisaged.

By way of example, FIG. 7 shows a system for capturing images comprising a sensor C having a curvature in the direction X (which is the direction of the optical axis A). This shape can be parabolic, or can comprise one or more extrema at a distance from its vertical edges (e.g. according to an M-shape in plan view), etc. In this case, the curvature of the sensor can in itself advantageously allow a partial correction of the field curvature introduced by the optics L, this correction involving the component of the field curvature in the direction X.

The adaptation of the focusing of light towards the sensor according to the part of the sensor exposed to light by the ERS, using an autofocus system such as described above, can then make it possible to further improve the quality of the captured image by correcting the field curvature effect in the direction Y perpendicular to the direction X.

Other combinations can of course be envisaged for obtaining a correction of the field curvature according to several of its components, as will become apparent to a person skilled in the art. For example, curvatures of the sensor in directions other than the direction X and a correction by synchronized usage of the autofocus system and the ERS in directions other than the direction Y are possible.

In addition to or as a replacement for the correction of the field curvature described hereto, the adaptation of the focusing of light towards the sensor for a part of the photosensitive elements exposed to light at a given moment can take account of an estimation of the object distance relative to a part of a scene to which said part of the photosensitive elements is exposed at said given moment.

According to the object distance which separates the optical system L from a part of the scene to be captured, the corresponding part of the image to be captured can be more or less sharp. In general, the range of object distances, i.e. distances along the optical axis between the object to be captured and the optical system, providing a sharp captured image is specific to a given system for capturing images and is called the depth of field.

The autofocus system AF synchronized with the ERS can provide a relative displacement of the optical system L and the sensor C in such a way that the focusing takes place substantially on a part of the sensor exposed to light at a given moment, taking account of the object distance.

Thus the sharpness of the captured image is improved, including for object distances situated outside the range defined by the depth of field associated with the optics L. In other words, the depth of field of such a system is increased by the synchronized action of the autofocus system AF and of the ERS.

This principle is shown in FIG. 5, where a system for capturing images such as described above is subjected to a scene O.

This scene O comprises a plurality of points, such as o1-o3, of which the object distances to the optical system L (e.g. d for the point o1) are different.

The autofocus system AF then ensures that the rays 1 and 2 originating from point o1 of the scene O focus substantially on the sensor C at a point o1′ which provides the sharpness of the image at this point.

Similarly, as the image o3′ of point o3 of the scene O, through the optical system L, is situated to the left of point o1′, the autofocus system AF will then ensure that the sensor C and the optics L move closer together, so that the image point o3′ is situated substantially on the sensor C at the moment when the corresponding part of the sensor is exposed to light by the ERS.

Similarly, a distancing of the optical system L and the sensor C will be carried out by the autofocus system AF synchronized with the ERS in order to obtain a sharp image o2′ of point o2 of the scene O to be captured, at the moment when the corresponding part of the sensor is exposed to light by the ERS.

For this purpose, a prior analysis of the scene to be captured (for example after a pre-capture view or “preview”) can be carried out before the capture of images. During this analysis, the autofocus system for example varies the relative distance between the optical system AF and the sensor C. A measurement of sharpness is carried out for certain positions originating from this variation of distances.

FIG. 6 shows an example in which three relative positions of the optical system L and the sensor C were tested at successive moments 4 to 6. The analysis reveals an image that is sharp in its lower part at moment 4 (the sharpness being symbolized by hatching). At moment 5, an intermediate portion of the image is sharp, while the lower and upper parts of this image are out of focus. Finally, at moment 6, it is the upper part of the image which is sharp, while the remainder of the image is out of focus.

Unlike the method of the prior art, a single intermediate position of the optics and the sensor is not chosen by the autofocus system for the whole of the following capture of images. On the contrary, the autofocus system will provide a relative displacement synchronized with the ERS in order to allow a focusing of light towards the sensor which provides a maximum sharpness for the different parts of the image as they were detected by the prior analysis.

Thus, diagrammatically, the relative position of the optical system L and the sensor C used during the capture will be substantially that corresponding to moment 6 as long as an upper part of the sensor is exposed to light by the ERS. Then a position corresponding substantially to moment 5 will be chosen for the moments when an intermediate part of the sensor will be exposed to light. Finally a position corresponding substantially to moment 4 will be selected for the end of the capture, if scanning the sensor by the ERS from top to bottom is involved.

This mode of operation can be used for example for capturing the image of a very high building. In this case, the focus is adapted to the distance of the top of the building for the upper part of the sensor, the distance of the middle of the building for the intermediate part of the sensor and the distance of the bottom of the building for the lower part of the sensor. In other words, the focusing is made closer in order to adapt to the convergence of the perspective. The virtual shape of the sensor can be compared in this case to a plane that is not perpendicular to the optical axis.

Similarly, if for reasons associated with production accuracy, the optical axis of the optical system L is not perpendicular to the sensor, the focusing synchronized with the ERS makes it possible to correct at least partially the blurring resulting from this tilting but without the need to predetermine the tilt, therefore without the additional costs of individual measurement on the production line.

As a variant or in addition to a relative displacement between the optical system and the sensor, the adaptation of the focusing in relation to the part of the sensor exposed by the ERS can be carried out by changing the shape and/or properties of the optical system synchronized with the ERS. Such a deformation or modification of properties of the optical system can for example be used when the latter comprises one or more liquid lenses. The use of a liquid crystal phase modulation device (DPLC) is an example of modification of properties of the optical system allowing the focusing to be adapted.

According to another example which can be combined with the previous ones, the autofocus system AF can, during a pre-capture view of a single image, vary the relative positions of the optical system L and the sensor synchronized with the ERS, in order to obtain respective focusings of light towards the sensor for different groups of photosensitive elements of the sensor. This variation of the relative positions of the optical system L and the sensor can for example be progressive and regular. The variation of focusing resulting therefrom leads to the existence of differences in sharpness within the pre-captured single image.

An analysis module of the system for capturing images then makes it possible to determine one of the groups of photosensitive elements of the sensor for which the sharpness satisfies a quality criterion. This quality criterion can be chosen so that the group of photosensitive elements having the best sharpness is adopted. It can for example consist of a measurement of contrast and comparison thereof with a predetermined threshold. Of course, other quality criteria can also be envisaged, as will become apparent to a person skilled in the art.

For capturing the image, the autofocus system can then adjust the relative displacement between the optical system and the sensor in relation to the focusing obtained for the group determined by the analysis module. This relative displacement can for example correspond to the relative positions of the optical system and the sensor which were used during the exposure by the ERS of the group of photosensitive elements determined during the pre-capture view of the image.

Thus, the chances are increased of having a correct, even optimal, focusing and therefore sharpness for at least part of the photosensitive elements of the sensor, even for the whole of the sensor if the scene captured is such that the object distance varies little.

Furthermore, the fact that the autofocus system is synchronized with the ERS during the pre-capture view of a single image makes it possible to obtain the optimal focusing in a particularly rapid and effective way.

To summarize, the first embodiment described hereto exploits the action of the electronic rolling shutter ERS in order to correct focusing defects such as field curvature generated by the optical system and/or the depth of field resulting from the object distance of the different parts of the scene to be captured and/or the blurring resulting from a manufacturing defect of the system for capturing images.

This is carried out for example by a relative displacement of the optical system and the sensor provided by the autofocus system for adapting the focusing to a part of the image exposed by the ERS at given moment. In a variant or in addition, a change of shape and/or properties of the optical system can be implemented.

This mechanism can be used at a single point or at successive moments during the scanning of the sensor by the ERS.

It will be noted that the first embodiment described is applicable to a system for capturing images comprising a zoom. In this case, the autofocus system will advantageously be arranged synchronized with the ERS in order to improve the sharpness of the images, once the focal length corresponding to the desired magnification has been chosen.

In a variant, the change of shape and/or properties of the optical system can consist of varying the enlargement factor of the zoom in a synchronized manner with the ERS in order to correct part of the geometric distortion of the system for capturing images. In fact the geometric distortion corresponds to a local magnification in the image which could be corrected for the photosensitive elements exposed at each moment by operating in a synchronized manner on the magnification factor of the optics. The geometric distortion originates from aberrations of the optical system but also from the geometry of the sensor. Thus in the variant embodiment consisting of using a curved sensor such as described in this document, it is possible to use the zoom in order to compensate for the impact of the curvature of the sensor on the geometric distortion.

Varying the enlargement factor of the zoom in a synchronized manner with the ERS also makes it possible to correct perspective effects and thus for example when photographing a building from ground level, to correct the latter in order to simulate a front elevation view taken at a greater height. The system for capturing images could thus advantageously allow the user to adjust his virtual photographing position, not only in the direction of the captured scene, as allowed by a zoom, but also in the perpendicular directions.

Varying the enlargement factor of the zoom in a synchronized manner with the ERS also makes it possible to simulate a projection of the image on any surface other than that of the sensor in order to correct for example face deformations in a group photo associated with volume anamorphosis.

According to a second embodiment, which can optionally be combined with the first, the means for adapting the system for capturing images comprise means for adapting the exposure to light for at least part of the photosensitive elements exposed to light by the ERS at a given moment. These means can adopt various forms.

According to a first example, they comprise means of selection of a gain factor and/or of an exposure time for photosensitive elements of the sensor, as a function of a previously estimated exposure. This principle is illustrated in FIGS. 8 and 12.

FIG. 12 shows the result of a prior analysis (for example following a pre-capture view or “preview”), making it possible to determine the exposure by zones of the image, before the definitive image capture.

In this example, the analysis allows three main zones of the image, and therefore of the sensor, to be detected. The upper zone 16 corresponds to a part of the image that is under-exposed and therefore too dark (symbolized by close hatching). The lower zone 18 corresponds to a part of the image that is overexposed and therefore too light (symbolized by the absence of hatching). The intermediate zone 17 corresponds, for its part, to a correctly exposed part of the image (symbolized by spaced-out hatching).

During the subsequent capture of images, the photosensitive elements of the sensor are controlled in order to represent an exposure which is a function of the results of the prior analysis. This control is moreover synchronized with the ERS, so that the exposure of the photosensitive elements is adjusted at the moment when the ERS exposes these photosensitive elements to light.

As shown in FIG. 8, an exposure adjustment module E can thus allocate a gain factor g(i,j) and/or an exposure time te(i,j) to each photosensitive element of position (i,j) inside the sensor C, i and j representing for example the position within a line and within a column respectively of the sensor C. Such a gain factor g(i,j) and/or such an exposure time te(i,j) modifies the exposure of the photosensitive element concerned and therefore influences the response of the latter.

The photosensitive elements e of the first lines of the sensor C starting from the top will thus be allocated a higher gain factor and/or exposure time than that (or those) of the last lines of the sensor, so as to compensate for the under-exposure of the former and the over-exposure of the latter, according to the results of the analysis carried out in the “preview”.

The photosensitive elements e of the intermediate lines of the sensor C will be allocated intermediate gain factor and/or exposure time values, in order to preserve their correct exposure as it was indicated by the analysis carried out in the “preview”.

FIG. 8 mentioned above assumes that a gain value and/or an exposure time can be independently selected for each of the photosensitive elements e of the sensor C. It is however possible to define gain factor and/or exposure time values for a whole group of photosensitive elements at once, for example for a line or a set of lines, a column or a set of columns, etc.

If for example, contrary to what was described with reference to FIG. 8, it is possible for the parameters modifying the exposure of the photosensitive elements not to be selected individually by photosensitive elements, but instead by group of photosensitive elements, or even for the whole of the sensor C, as this will not cause a problem inasmuch as the values selected will only be activated for the photosensitive elements exposed to light by the ERS. It will therefore be necessary to ensure, in this case, that the pertinent values of the parameters are selected in relation to the part of the sensor exposed to light by the ERS at a given moment, or at successive moments throughout the electronic scanning of the sensor.

As a replacement or in addition to the gain factor and/or the exposure time mentioned above, other parameters relating to the photosensitive elements of the sensor could be adapted with the aim of improving their exposure to light during the capture of an image.

As a result of this correction, the captured image can then be exposed correctly over the whole of its area, independently of the fact that certain parts of the sensor are more or less well exposed naturally, either due to defects of the system for capturing images, or due to the nature of the scene to be captured which can comprise parts having more or less brightness.

By way of example, the phenomenon of vignetting can be limited as a result of this embodiment of the invention. It will be recalled that vignetting is a defect associated with the photographing system which is manifested by an unequal distribution of the light in the image: the brightness is greater at the centre than at the periphery. The vignetting is due to both the optics and the sensor.

By affecting exposure of the photosensitive elements of the sensor synchronized with the ERS, it is in fact possible to compensate for this imbalance, so that the centre and the periphery of the captured image have a comparable brightness, avoiding the undesirable effects of the conventional correction methods by applying a digital gain afterwards, which increases the noise.

As an alternative or in addition, adapting the exposure to light for at least part of the photosensitive elements exposed to light by the ERS can result from lighting the scene to be captured by a lighting module such as a flash.

In this case, the light intensity of the lighting module can be adapted as a function of the photosensitive elements of the sensor exposed to light by the ERS at a given moment.

In the case where an analysis carried out in the “preview” gives the results already mentioned with reference to FIG. 12, the system for capturing images can then activate a flash, the intensity of which is high while the ERS exposes to light the photosensitive elements of the sensor corresponding to the upper part 16 of FIG. 12, then an intermediate value when the photosensitive elements corresponding to the part 17 are exposed to light, and finally a low or even zero value when the ERS exposes to light the photosensitive elements of the last lines of the sensor corresponding to the zone 18.

Here again, the captured image can then be exposed correctly over the whole of its area, independently of the fact that certain parts of the sensor are more or less well exposed naturally, either due to defects of the system for capturing images, or due to the nature of the scene to be captured which can comprise parts having more or less light intensity.

When the flash has only two possible states (on or off), it can be activated with respect to only part of the photosensitive elements of the sensor, the flash remaining off when the ERS exposes to light the other photosensitive elements of the sensor.

As an alternative or in addition, adapting the exposure to light for at least part of the photosensitive elements exposed to light by the ERS can result from an adjustment of the size of the iris of the system for capturing images. The aperture of the optical system L can be varied, for example by varying the opening or closing of the diaphragm of the system for capturing images (STOP in FIG. 5) synchronized with the ERS in order to allow a suitable quantity of light to pass through.

According to another example which can be combined with the previous ones, the system for capturing images can comprise a first and a second lighting modules in order to light a scene to be captured. These modules can be separate or merged. The first lighting module can for example implement a preflash, while the second is a flash.

With this configuration, it is possible to vary the light intensity of the first lighting module synchronized with the electronic rolling shutter ERS so as to obtain respective exposures to light for different groups of photosensitive elements of the sensor. By way of example, the intensity of the first lighting module can be according to an increasing function of time, for example linear or affine, during the scanning by the ERS.

If the first lighting module has only two possible states (on or off), a simple variation of state (all or none) can be used which would have the effect on the image of a variation of exposure according to whether the integration of a given line starts, ends or takes place wholly during the time the lighting module is lit.

Thus an image is obtained (for example in the “preview”) the exposure of which varies according to the position in the image.

An analysis module of the system for capturing images then makes it possible to determine one of the groups of photosensitive elements of the sensor the exposure of which satisfies a quality criterion. This quality criterion can be chosen so that the group of photosensitive elements having the best average exposure is adopted. It can for example consist of a measurement of contrast and its comparison with a predetermined threshold. Of course, other quality criteria can also be envisaged, as will become apparent to a person skilled in the art.

For the capture of the image, the second lighting module can then light the scene to be captured with a light intensity which is a function of the exposure thus determined. The intensity can for example be adopted equal to that of the first lighting module for the group of photosensitive elements determined for its exposure quality.

Thus, the intensity of the second lighting module makes it possible to increase the chances of having a correct or even optimal exposure for at least part of the photosensitive elements of the sensor, or even for the whole of the sensor if the captured scene has relatively little contrast.

By way of example, it is considered that an image of the type of that shown in FIG. 13 is obtained in the “preview” using a variation, for example linear or affine, of the light intensity of the first lighting module synchronized with the ERS. This image is increasingly sharp from top to bottom, as symbolized by the use of dots that are increasingly spaced out.

It is assumed that an analysis of this image makes it possible to deduce that the intermediate photosensitive elements of the sensor corresponding to the zone 21 have the best exposure, so that the light intensity of the second lighting module can be adjusted in relation to this exposure.

For this purpose, the light intensity of the second lighting module can be adopted equal or close to that of the first lighting module at the moment when the photosensitive elements corresponding to the zone 21 have been exposed to light by the ERS.

The rest of the description can apply to any embodiment of the invention, as it relates to means for adapting the focusing of light towards the sensor and/or the exposure to light.

The conventional sensors are generally rectangular and the conventional electronic rolling shutters carry out scanning of these sensors by lines following the largest dimension of the sensors. Thus, in the case of a rectangular sensor, the scanning is generally carried out line by line in the lengthwise direction.

Whatever use is made of the ERS in order to improve the quality of the captured images, certain examples of which have been described above, electronic scanning of the ERS can advantageously be provided in order to expose to light, starting from successive moments, lines of photosensitive elements taken following the smallest dimension of the sensor.

In the example shown in FIG. 9, this means that the scanning by the ERS takes place by columns 9 of successive photosensitive elements of the sensor (column by column, or group of columns by group of columns), the columns following the height 7 of the sensor, rather than by successive lines following the length 8 of the sensor.

Accordingly the adaptation of the focusing of light towards the sensor and/or the exposure to light can be adapted to a more limited part of the photosensitive elements of the sensor.

As a column of the sensor comprises fewer photosensitive elements than a line, the variations of the field curvature, the object distance and/or the exposure to light are smaller on a column than on a line. Adapting the focusing of light towards the sensor and/or the exposure to light for a column of photosensitive elements, synchronized with the ERS, can therefore lead to an improvement in the quality of the image greater than that which would be obtained for a line of photosensitive elements.

Of course, this improvement in quality has a concomitant increase in the number of adaptations necessary, which is manifested for example by an increase in the number of displacements controlled by the autofocus system in the case of the focusing, or in the number of selections of parameters of exposure of the photosensitive elements or the number of flash intensity values to be implemented during the capture of an image.

The scanning mode of the ERS can therefore be chosen in relation to a compromise to be made between the desired image quality and the number of adaptations of the focusing of light towards the sensor and/or the exposure to light for a capture of images.

It will be understood furthermore that other types of scanning can be provided for the ERS, in addition to the above-mentioned scanning by lines or by columns. A combination of scanning by lines and by columns is for example possible. Non-linear scanning of the sensor, for example circular or semi-circular, can also be envisaged. In all cases, the adaptation of the focusing of light and/or the exposure to light will be carried out in a corresponding manner and synchronized with the scanning adopted for the ERS.

According to another example shown in FIG. 10, the ERS simultaneously exposes to light symmetrical lines of photosensitive elements of two halves 10 and 11 of the sensor.

When the scanning of the photosensitive elements is carried out not only from one line to another, but also within each of the lines, it is possible for example to provide for scanning the lines in a certain direction for the half 10 of the sensor and in an opposite direction for the other half 11 of the sensor, as shown by the arrows apparent in FIG. 10.

Thus, two points 12 and 13 of the sensor, symmetrical with respect to a centre of the sensor, are simultaneously exposed to light by the ERS. This is advantageous to the extent that most optical systems are symmetrical about the optical axis, although certain defects, such as the field curvature, can have the same value for photosensitive elements symmetrical with respect to the centre of the sensor (which is most often on the optical axis).

In such a case, the relative position of the optical system and of the sensor determined by the autofocus system synchronized with the ERS is therefore valid both for the photosensitive elements 12 and 13. It makes it possible to compensate simultaneously for the field curvature that is identical at these two points. The number of displacements provided by the autofocus system is thus reduced, without degrading the quality of the captured images.

According to yet another example, the scanning of the photosensitive elements is carried out in a spiral or helix. Thus, the ERS could expose to light the photosensitive elements of the sensor by starting from the edges of the latter, then moving progressively closer to those of the centre, or vice-versa.

On the assumption that the ERS exposes the photosensitive elements of the sensor for a fixed exposure time, (as is the case in FIG. 1 for example), the longer this exposure time, the greater the proportion of the sensor exposed to light at a given moment. The result is that an adaptation of the focusing of light towards the sensor and/or the exposure to light for this part of the sensor is even more imprecise, as the variations of the field curvature, the object distance and/or the exposure are potentially numerous in this situation.

This would provide an incentive to reduce to the maximum the exposure time of each photosensitive element of the sensor. However, an exposure time that is too short leads to a signal acquisition that is potentially too weak, which can cause a degradation of the quality of the captured image.

Letting te be a given exposure time for which it is estimated that the acquired signal allows a sufficient image quality, the above-mentioned problem can advantageously be solved by carrying out a succession of acquisitions of images with an exposure time less than te, then accumulating the different images acquired.

The ERS can for example be adjusted in order to expose the photosensitive elements of the sensor, N number of times to light for a time reduced for example to te/N, in order to obtain N images each corresponding to a fraction of the exposure to light time te.

With reference to FIG. 11, if the exposure time te leads the ERS to expose the photosensitive elements of the sensor by three-line groups 14, it is then possible for example to modify the ERS so that it can successively expose each line 15 of photosensitive elements (which corresponds to N=3).

The adaptation of the focusing of light towards the sensor and/or the exposure to light according to the invention can thus be carried out for each line 15 of photosensitive elements individually. Such an adaptation, which applies to a part of the sensor three times smaller than in the nominal case, leads to a better correction of the focusing defects and/or improvement in the exposure with respect to the nominal case.

A first image is thus obtained with an improved quality on completion of the first full line-by-line scan of the sensor by the ERS.

This operation is repeated two more times, in order to obtain a total of three images corresponding to three full line-by-line scans of the sensor by the ERS, with an exposure time of te/3 for each photosensitive element.

These three images can finally be accumulated in order to obtain a signal quantity equal to the sum of the signal quantities of each of the three images. The sole image resulting from this combination is comparable in signal quantity to an image corresponding to the exposure time te, but its quality is higher as it originates from images that are finely corrected with respect to the focusing defects and/or exposure problems.

As indicated above, the invention can apply to the capture of fixed or animated images.

In the case of a video mode operation for the capture of animated images, it will be noted that the exposure of an image n+1 can start before the end of exposure of a preceding image n. This does not really cause a problem when the exposure time is short, as the overlap between the exposures of the successive images is then limited. If the exposure time is very high, care will be taken to optimize the adaptation of the focusing of light towards the sensor and/or the exposure to light in order to take account of the overlap between the exposures of the successive images.

The means for adapting the focusing of light towards the sensor and/or the exposure to light synchronized with the ERS can be incorporated into a conventional system for capturing images, for which other measures are already provided in order to improve the quality of the images acquired. In this case, the quality of the images acquired will be further increased, for example by compensating for the focusing defects and/or by improving the exposure of the photosensitive elements of the sensor.

As an alternative, the system for capturing images implementing the invention can comprise an optical system having a controlled quantity of focusing defects and/or it can have a controlled quantity of errors in the response of the photosensitive elements of the sensor to a given exposure (e.g. due to the phenomenon of vignetting or other).

In this case, said controlled quantities are advantageously chosen in such a way as to be capable of being compensated for by the action of the means for adapting the focusing of light towards the sensor and/or the exposure to light. Thus acquired images of acceptable quality can be obtained from a system for capturing images that is of a limited quality and/or low cost.

In addition to the description given above, the invention can consist of exploiting the functioning of the electronic rolling shutter ERS in order to improve the quality of the images acquired. This improvement can result from an adaptation of the focusing of light towards the sensor, the exposure to the light or also other phenomena capable of leading to an improvement in the acquisition of images.

1. A system for capturing images, comprising:
a sensor including a plurality of photosensitive elements;
an optical system for focusing light towards the sensor;
an electronic rolling shutter configured to expose the photosensitive elements to light at moments that depend on the relative positions thereof inside the sensor; and
adapting means for adapting, at each of two distinct moments during an image capture, the focusing of light towards the sensor and/or the exposure to light for at least part of the photosensitive elements exposed to light at the moment.

2. A system for capturing images according to claim 1, in which said adapting means include an autofocus system configured to provide, for each of the two distinct moments, a relative displacement between the optical system and the sensor, the autofocus system being synchronized with the electronic rolling shutter so as to adapt the focusing of light towards the sensor for said part of the photosensitive elements exposed to light at the moment.

3. A system for capturing images according to claim 1, in which said adapting means comprise means for changing, for each of the two distinct moments, a form and/or properties of the optical system and/or of the sensor and/or of the system for capturing images so as to adapt the focusing of light towards the sensor for said part of the photosensitive elements exposed to light at the moment.

4. A system for capturing images according to claim 2, in which the adapting means are also for taking account, for each of the two distinct moments, of a field curvature introduced by the optical system at a level of said at least part of the photosensitive elements exposed to light at the moment.

5. A system for capturing images according to claim 2, in which the adapting means are also for taking account, for each of the two distinct moments, of an estimation of an object distance relative to a part of a scene to which is exposed at least said part of the photosensitive elements exposed to the light at the moment.

6. A system for capturing images according to claim 2, in which the sensor has a curvature substantially in a first direction and in which the adapting means are also for taking account, for each of the two distinct moments, of a component, in a second direction perpendicular to the first direction, of at least one focusing defect at a level of said at least part of the photosensitive elements exposed to light at the moment.

7. A system for capturing images according to claim 1, in which said adapting means are synchronized with the electronic rolling shutter so as to obtain, during a pre-capture view of a first image, respective focusings of the light towards the sensor for different groups of photosensitive elements of the sensor exposed to light during the respective focusings, the system for capturing images also comprising an analysis module for determining one of said groups for which a sharpness of said first image satisfies a quality criterion, said adapting means also being for adjusting, during a capture of a second image, the focusing of light towards the sensor in relation to the focusing obtained for the group determined by the analysis module.

8. A system for capturing images according to claim 1, in which said adapting means comprise means for selecting, for each of the two distinct moments, a gain factor and/or an exposure time for said part of the photosensitive elements exposed to light at the moment as a function of a previously-estimated exposure of said at least part of the photosensitive elements exposed to light at the moment.

9. A system for capturing images according to claim 1, comprising a lighting module configured to light a scene to be captured, and in which said adapting means comprise means for adjusting, at each of the two distinct moments, a light intensity of the lighting module as a function of a previously-estimated exposure of said at least part of the photosensitive elements exposed to light at the moment.

10. A system for capturing images according to claim 1, in which said adapting means comprise means for adjusting, for each of the two distinct moments, an aperture of the optical system at the moment, so as to adapt the focusing of light towards the sensor and/or the exposure to light for said part of the photosensitive elements exposed to light at the moment.

11. A system for capturing images according to claim 1, in which said adapting means comprise means for adjusting, for each of the two distinct moments, a focal length of the optical system at the moment, so as to adapt the focusing of light towards the sensor and/or the exposure to light for said part of the photosensitive elements exposed to light at the moment.

12. A system for capturing images according to claim 1, comprising a first and a second lighting modules configured to light a scene to be captured, in which said adapting means comprise means for varying a light intensity of the first lighting module synchronized with the electronic rolling shutter so as to obtain respective exposures to light for different groups of photosensitive elements of the sensor, the system for capturing images moreover comprising an analysis module for determining one of said groups the exposure of which satisfies a quality criterion and means for adjusting a light intensity of the second lighting module in relation to the exposure obtained for the group determined by the analysis module.

13. A system for capturing images according to claim 1, in which the electronic rolling shutter is configured to expose to light, starting from successive moments, lines of photosensitive elements taken following a smallest dimension of the sensor.

14. A system for capturing images according to claim 1, in which the electronic rolling shutter is configured to simultaneously expose to light symmetrical lines of photosensitive elements of two halves of the sensor.

15. A system for capturing images according to claim 1, in which, in order to obtain an image corresponding to a given exposure to light time of the photosensitive elements of the sensor, the electronic rolling shutter is configured to expose the photosensitive elements to light, N number of times, for a fraction of the given time for exposure to light so as to reduce the number of photosensitive elements exposed at a given moment, and so as to obtain N images each corresponding to a fraction of the given exposure to light time, the system for capturing images comprising moreover means for accumulating the N images in a single image, the focusing of light towards the sensor and/or the exposure to light being adapted to the reduced number of photosensitive elements exposed to light during said fraction of the given exposure time.

16. A system for capturing images according to claim 1, in which the optical system has a controlled quantity of focusing defects and/or the system for capturing images has a controlled quantity of errors in a response of the photosensitive elements of the sensor to a given exposure, said controlled quantities being chosen in such a way as to be capable of being compensated for by the adapting means.

17. A method of using a system for capturing images that includes a sensor including a plurality of photosensitive elements, an optical system for focusing light towards the sensor and an electronic rolling shutter arranged to expose the photosensitive elements to the light at moments that depend on relative positions of the photosensitive elements inside the sensor, the method comprising:
adapting at a first moment of an image capture, the focusing of light towards the sensor and/or the exposure to light for at least part of the photosensitive elements exposed to light at the first moment; and
adapting at a second moment of an image capture, the focusing of light towards the sensor and/or the exposure to light for at least part of the photosensitive elements exposed to light at the second moment.
